(19) United States
(12) Patent Application Publication
(10) Pub. No.: US 2013/0036061 A1
(43) Pub. Date: Feb. 7, 2013

(54) PRODUCT RECALL INFORMATION MANAGEMENT

(71) Applicants: Eugenie L. Alexander, Spokane, WA (US); Arthur J. Bariska, JR., Tucson, AZ (US); Matthew T. Cousens, Catskill, NY (US); Eileen S. Kovalchick, Tucson, AZ (US); Joel L. Masser, San Jose, CA (US); Kevin D. McKenzie, Poughkeepsie, NY (US); Eileen P. Tedesco, Sharon, CT (US)

(72) Inventors: Eugenie L. Alexander, Spokane, WA (US); Arthur J. Bariska, JR., Tucson, AZ (US); Matthew T. Cousens, Catskill, NY (US); Eileen S. Kovalchick, Tucson, AZ (US); Joel L. Masser, San Jose, CA (US); Kevin D. McKenzie, Poughkeepsie, NY (US); Eileen P. Tedesco, Sharon, CT (US)

(73) Assignee: INTERNATIONAL BUSINESS MACHINES CORPORATION, Armonk, NY (US)

(21) Appl. No.: 13/196,719

(22) Filed: Aug. 2, 2011

(51) Int. Cl. G06Q 10/00

(52) U.S. Cl. 705/303

(57) ABSTRACT

An approach to providing relevant product safety information. Product recall information is aggregated from Internet sources into a database of product recall information. Product identification is gathered from products in the consumer's possession. The product identification may be gathered by having a computing device communicate with the products and store the product information in a data structure such as a table in a database. The product identification for the products is compared with the product recall information, and the consumer is notified of product recall information that is associated with one or more of the products. A computer implementing the system may cause the products themselves to notify the consumer. The consumer may also be notified by text message or email. The consumer may also set a sensitivity indicator that specifies conditions to be met before the consumer receives a notification.

### FIELD

The subject matter disclosed herein relates to managing product recall information.

### BACKGROUND

### Description of the Related Art

Occasionally, products sold to consumers are later found to be defective or in some way unsafe. The company that produced the product, or other companies involved in the product's sale and distribution, may issue a product recall. The product recall requests that consumers who purchased the product return it to the maker, generally for replacement, repair, or a refund.

Consumers, of course, are interested in whether products they own are unsafe or are being recalled for other reasons. But it can be difficult to find out about safety recalls. Few consumers regularly check each of the disparate websites and other sources of product recall information. It can also be difficult to determine the scope of a particular recall; for example, a product recall directed at cars may affect only a certain model made during certain years. Checking the Vehicle Identification Number (VIN) may be necessary to determine whether a particular vehicle is affected by the recall.

Given these challenges, consumers often don't know whether they own products that have been recalled. Many recalls do not get sufficient media attention or airtime to successfully reach consumers. Few consumers have the time or inclination to manually search through product recall information. Attempting to keep abreast of current product recall information is a challenge. Consumers that purchase products second hand often don't provide the manufacturer with their contact information. Thus, even a conscientious manufacturer attempting to reach purchasers of their products will not be able to reach all consumers who have their products in their possession. That consumers may continue to use unsafe products poses a significant risk, both to the consumers and to those around them. An improved approach to determining whether a consumer owns product affected by a recall would be valuable.

### BRIEF SUMMARY

An approach to managing product recall information is disclosed. The summary that follows is for convenience, and is not a limitation on the claims. In one embodiment, the invention is realized as a computer program product for providing relevant product safety information. The computer program product may comprise instructions for aggregating product recall information from a plurality of Internet sources into a database and for gathering product identification for products in a consumer's possession. The computer program product may gather this product identification by communicating with the products and storing the product information in a data structure such as a list, table, or other variety of data structure. The computer program product may also compare the product identification for the products and the product recall information, and notify the consumer of the product recall information that is associated with one or more of the products.

The invention may also be realized as a system that includes a first computing device and a second computing device. The first computing device may belong to the consumer and be a home computer, tablet, or other computing device. The second computing device may be a server. The first computing device may be configured to gather product identification for products in the consumer's possession by communicating with the products and storing the product information in a data structure. The first computing device may compare the product identification for the products with product recall information and notify the consumer of the product recall information that is associated with one or more of the products. The second computing device may be configured to aggregate the product recall information from a plurality of Internet sources into a database, and to communicate the product recall information to the first computing device.

The invention may also be realized as a method. The method may be implemented on a computer. The method may involve aggregating product recall information from a plurality of Internet sources into a database and gathering product identification for products in the consumer's possession by communicating with the products and storing the product information in a data structure. The method may also involve comparing the product identification for the products and the product recall information, and notifying the consumer of the product recall information that is associated with one or more of the products.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is an illustrative block diagram showing one embodiment of a system for providing relevant product safety information;

FIG. 2 is an illustrative block diagram illustrating one embodiment of a computing device communicating with various products;

FIG. 3 is an illustrative block diagram illustrating one embodiment of a product recall apparatus gathering product recall information from a variety of recall sites;

FIGS. 4a and 4b are illustrative diagrams showing a product and a phone notifying a consumer of product recall information;

FIG. 5 is a flow chart diagram showing one embodiment of a method for providing relevant safety information; and

FIG. 6 is a flow chart diagram showing one embodiment of a method for gathering product identification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in microcode, firmware, or the like of programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. The computer readable medium may be non-transitory.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-Ray Disc (BD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fibre cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fibre optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. These computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

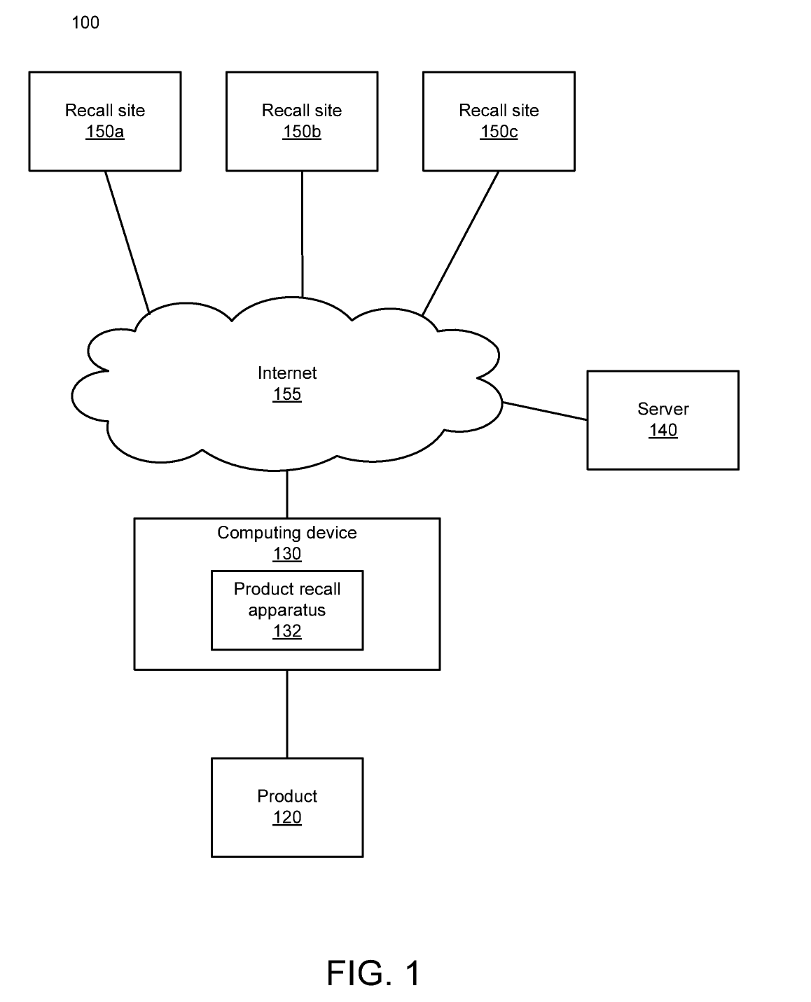

FIG. 1 depicts one embodiment of a system 100 for providing relevant safety information to a consumer. FIG. 1 depicts one embodiment of the system 100, and other variations are possible. In the depicted embodiment, the system 100 includes recall sites 150a-c, Internet 155, server 140, computing device 130, and product 120.

The computing device 130 is a tangible machine capable of performing computations and sending and receiving data. The computing device 130 may be, for example, a desktop computer, a laptop computer, a smart phone, a tablet, or other variety of computing device 130. The computing device 130 is depicted as including a product recall apparatus 132. In certain embodiments, the product recall apparatus 132 is distributed to various locations in the system 100; for example, a component of the product recall apparatus 132 may be located on the server 140, and components of the product recall apparatus 132 may be on the product 120.

The product recall apparatus 132 may be configured to provide a consumer using the computing device 130 with relevant product safety information. The product recall apparatus 132 may do so by aggregating product recall information from a plurality of Internet 155 sources (such as the recall sites 150a-c), gathering product information for products 120 in the consumer's possession, comparing the product identification for the products 120 with the product recall information, and notifying the consumer of the product recall information that is associated with one or more products 132 owned by the consumer.

The Internet 155 is a system of interconnected computer networks that allow information to be exchanged between machines and users. Computers, such as the computing device 130 and the server 140, can share information over the Internet 155.

Recall sites 150a are websites hosted by computers that provide product recall information. As used herein, product recall information refers to information relevant to the safety of continued use of a product 120. The product recall information may be formal recalls issued by a government agency. The product recall information may be voluntary recalls issued by a company. The product recall information may include third-party reports of safety problems or concerns with a particular product 120 or a class of product 120. For example, a news agency may report on an E. Coli outbreak that experts suspect is being spread by spinach. Such a report qualifies as product recall information.

The product 120 may be any product that a consumer may possess. The product 120 may be, for example, furniture, an appliance, an electronic device, a car, food, or other product that a consumer may possess. As explained above, certain products 120 may be sold and defects or safety concerns for those products 120 may be discovered after sale. Advantageously, the system 100 allows the consumer to receive product recall information for affected products 120 in a convenient manner.

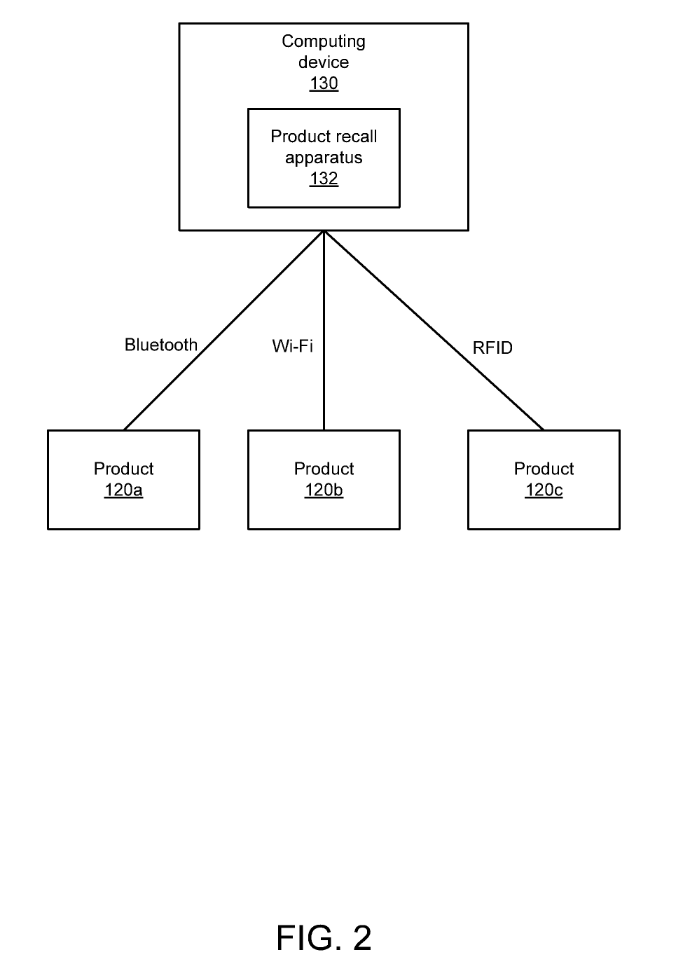

FIG. 2 shows one embodiment of a computing device 130 with a product recall apparatus 132 and products 120a-c. In the embodiment depicted in FIG. 2, the products 120a-c are capable of communication information directly with the computing device 130. The product 120a may be a car with Bluetooth capability. The product 120b may be a television with Wi-Fi capability. The product 120c may be a food product with a radio frequency identification (RFID) tag and capable of RFID communication.

The product recall apparatus 132 may be configured to gather product identification for products 120a-c by communicating with the products 120a-c and storing the product information in a data structure. The product recall apparatus 132 may, for example, communicate directly with the product 120a via Bluetooth without the consumer having to provide any input. In other embodiments, the product recall apparatus 132 may communicate with the products 120a-c directly, but require the consumer to allow the communication to occur. The product recall apparatus 132 may provide the consumer with a list of possible products 120a-c with which the product recall apparatus 132 can communicate, and request the consumer's permission to communicate with the products 120a-c and to gather product information.

Product information, as used herein, refers to information that identifies the product 120 and that provides information about the product. The product information may, but need not, uniquely identify the product 120. For example, the product information may be the name of the product 120 or the type (e.g., food product, medicine, appliance, etc) of the product 120. The product information may also include information about the manufacture of the product 120. For example, the product information may include the serial number of the product 120, a vehicle identification number (VIN), a batch number, a date of manufacture, or other information. The product information may be stored in the product 120 itself, such as an appliance, or other device with memory. The product information may be stored in an RFID tag for the product 120. The product information may also be stored in a bar code associated with the product, or in financial records associated with the purchase of the product.

In certain embodiments, the product recall apparatus 132 uses a combination of approaches to gather product information about the products 120. The product recall apparatus 132 may allow the consumer to enter the product information. The product recall apparatus 132 may, for example, provide the consumer with a data entry option of a graphical user interface (GUI) associated with the product recall apparatus 132. The product recall apparatus 132 may receive gather the product information by a user scanning the products 120. The user may be the consumer who scans the product 120 if the computing device 130 implementing the product recall apparatus 132 provides technology that can read bar codes, Quick Response (QR) codes, or other approaches to codes that can provide product information.

The user may be a check-out clerk or other individual who scans the products 120 at a time of purchase. The product recall apparatus 132 may be configured to extract product information from the transaction records associated with the purchase of the products 120a-c. For example, if the consumer purchases the product 120 with a credit card, the purchase may generate an electronic record of the transaction. The product recall apparatus 132 may be configured to access the electronic record of the transaction and to extract product information from the record.

A combination of approaches to gathering product identification may be used. For example, the product recall apparatus 132 may implement all of the strategies for gathering product identification described above. In such embodiments, the product recall apparatus 132 may be configured to identify redundancies that may occur due to gathering product information through the different approaches and to consolidate redundant entries into a single entry in the data structure.

The data structure in which the product information is stored may be any of a variety of suitable data structures. For example, the data structure may be a list. The data structure may be a table in a database. Other suitable data structures for storing product information may also be used. The product recall apparatus 132 may allow the consumer to print or view the data structure and thus review the products 120 that are contained therein. The product recall apparatus 132 may also allow the consumer to edit the data structure. The data structure may provide additional benefits beyond its use in identifying relevant product safety information; for example, the data structure may allow the consumer to easily maintain an inventory of products 120 that are currently in her home, office, or other space, which may be useful for insurance purposes.

In certain embodiments, products 120 may have a limited lifespan. The product recall apparatus 132 may be configured to determine a lifetime for one or more of the products 120. In one embodiment, the product recall apparatus 132 may estimate the lifetime of the product 120. For example, if the product 120 is a perishable item such as fruit or vegetables, the product recall apparatus may estimate the lifetime of the product 120 to be two weeks. The product recall apparatus may be configured to remove the products 120 with a lifetime from the data structure when the lifetime of the product is complete. To continue the example above, the product recall apparatus 132 may determine that the consumer has purchased apples on a particular date and estimate the lifetime of the apples to be two weeks. The product recall apparatus 132 may add the apples to the data structure. After the two-week lifetime is complete, the product recall apparatus 132 may remove the apples from the data structure.

In certain embodiments, the product recall apparatus 132 may be able to determine the lifetime of a product 120 from the product 120. The product recall apparatus 132 may, for example, extract information concerning the expiration date of the product 120. The consumer may enter the expiration date, the expiration date may be read by the computing device 130 directly from the product 120 (via a label, bar code, or other indicator), or determined by the product recall apparatus 132 based on information entered about the product 120 (such as the date of manufacture, serial number, or other).

The product recall apparatus 132 may set the lifetime to expire on the expiration date for the product 120. In certain embodiments, the product recall apparatus 132 also notifies the consumer that the product has expired when the expiration date is set. The product recall apparatus 132 may provide such notifications for only certain categories of products 120; for example, for products 120 that fit within the category of medicine. Certain products 120 that may expire may simply be removed from the data structure without providing the consumer with a notification that the product 120 has expired. For example, a consumer may not want to be alerted as to the expiration date (real or estimated) of every food item that is in the consumer's possession. In certain embodiments, the consumer can configure the product recall apparatus 132 to provide notification of expiration for only certain classes of product 120.

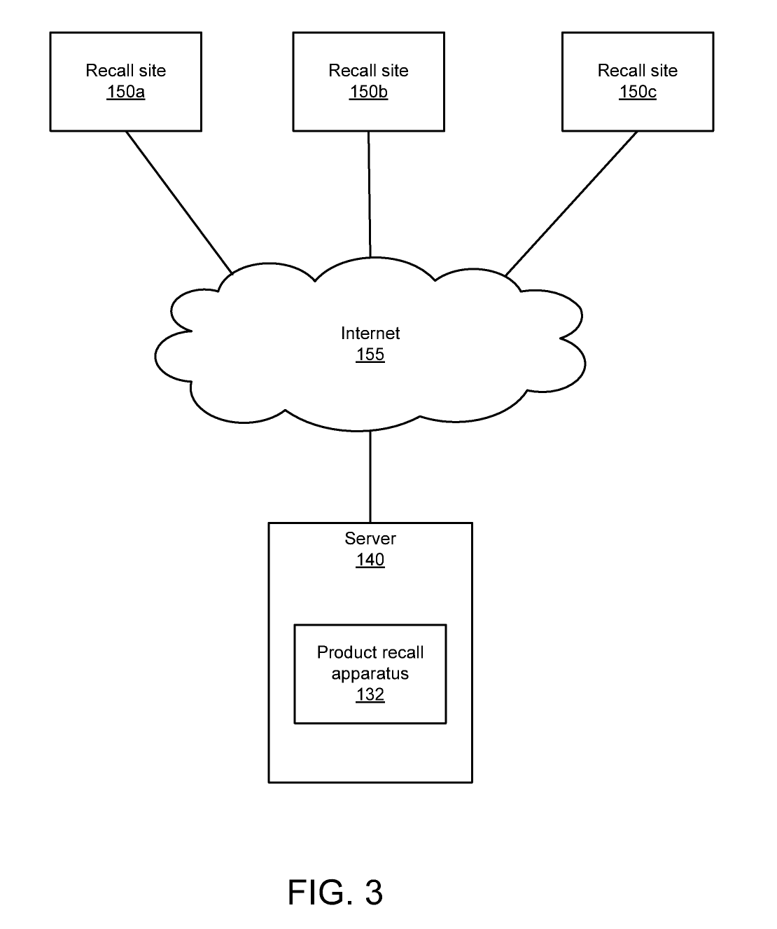

FIG. 3 shows one embodiment of a server 140 with a product recall apparatus 132. The depicted server 140 can connect to recall sites 150a-c through the Internet 155. As mentioned above, certain components of the product recall apparatus 132 may be located on a computing device 130 that connects to the server 140 over the Internet 155.

In one embodiment, the product recall apparatus 132 may aggregate product recall information from a plurality of Internet 155 sources into a database. In the depicted embodiment, the database may be located on the server 140. In such embodiments, the server 140 may aggregate the product recall information from the recall sites 150a-c and make that database available to components of the product recall apparatus 132 operating on the computing devices 130 belonging to various consumers. The product recall apparatus 132 may aggregate the product information and push the aggregated information to databases on the computing devices 130. In certain embodiments, the component of the product recall apparatus 132 responsible for aggregating product recall information is located in the computing device 130. In such embodiment, each computing device 130 may be individually responsible for aggregating the product recall information and storing it into a database.

Recall sites 150a are websites hosted by computers that provide product recall information. As noted above, product recall information refers to information relevant to the safety of continued use of a product 120. In certain embodiments, the product recall apparatus 132 maintains a list of trusted recall sites 150 and automatically searches the recall sites 150 that are in that list for product recall information. In certain embodiments, the list of trusted recall sites 150 is modifiable by a user, such as the consumer, or an administrator providing support for the product recall apparatus 132.

In certain embodiments, the product recall apparatus 132 crawls multiple websites to identify the recall sites 150a-c that include product recall information. The product recall apparatus 132 may search for keywords that indicate the presence of product recall information the product recall apparatus 132 may extract the product recall information from one or more recall sites 150a-c. The product recall information that is extracted may include the names of the products 120 affected by the product recall information, information that identifies the range of products 120 affected by the product recall information (such as the serial numbers, dates of manufacture, dates of sale, etc). The product recall apparatus 132 may load this information into a database on the server 140 allowing for easier and faster searching of product recall information.

In one embodiment, the product recall apparatus 132 is configured to search for and eliminate redundant entries of product recall information. Multiple recall sites 150 may include the same product recall information. The product recall apparatus 132 may be configured to determine whether product recall information found on a recall site 150a has already been entered into the database due to its existence on another recall site 150b. The product recall apparatus 132 may check the product recall information it has found on the recall site 150a to see if the entry to be made in the database based on the product recall information will differ from existing entries in the database. If the entry will be identical to an existing entry, the product recall apparatus 132 may forgo creating a new entry containing the identical product recall information. The product recall apparatus 132 may modify the existing entry to note each recall site 150 that reported the product recall information.

In one embodiment, the product recall apparatus 132 allows a user, such as administrator, to determine whether product recall information is duplicative. The product recall apparatus 132 may alert a user of the existence of possible duplication of the product recall information and allow the user to indicate whether it is, in fact, duplicative of existing information in the database.

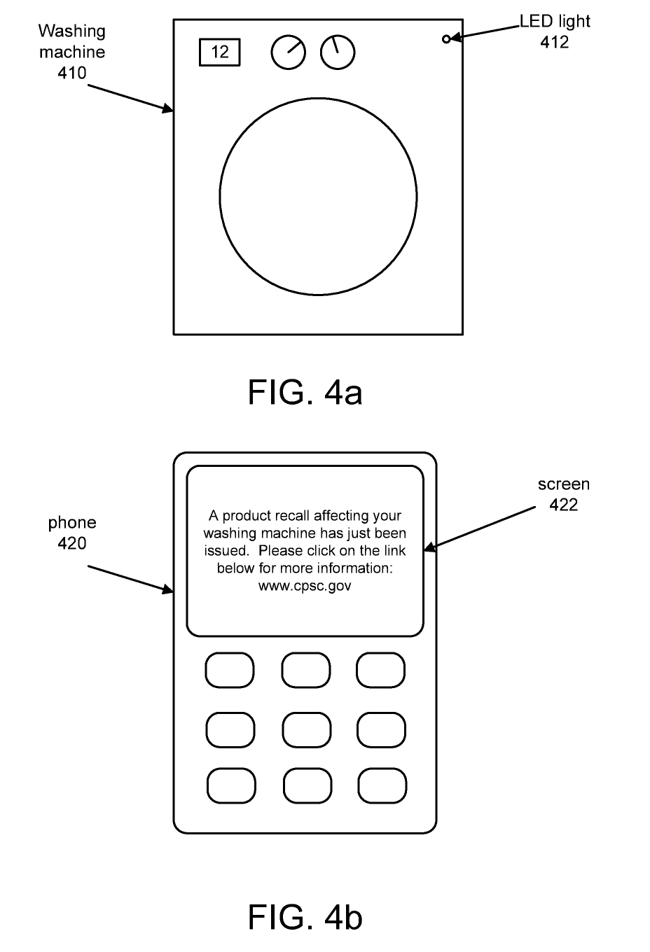

FIGS. 4a and 4b illustrate embodiments of devices notifying a consumer of the product recall information. FIG. 4a depicts an embodiment of a product 120 that is a washing machine 410. As described above, the product recall apparatus 132 may compare product identification for the washing machine 410 with product recall information gathered from various Internet sources. If there is product recall information for the washing machine 410, the product recall apparatus 132 notifies the consumer of the product recall information that is associated with the washing machine 410.

In certain embodiments, the washing machine 410 (or other comparable products 210) may have display mechanisms such as the LED light 412. Other display mechanisms may also be used. The product recall apparatus 132 may be capable of communicating information with the washing machine 410 and causing the washing machine 410 to provide the notification. For example, the product recall apparatus 132 may send instructions to the washing machine 410 that cause the LED light 412 to blink in a specified pattern. The product recall apparatus 132 may cause the product 120 to beep or otherwise provide an audio indicator. Certain products 120 may have a screen that allows the product 120 to display messages. The product recall apparatus 132 may cause the product 120 to display a message for the consumer on the screen.

FIG. 4b shows one embodiment of a phone 420 that may be associated with a consumer. In one embodiment, the product recall apparatus 132 notifies the consumer of the product recall information by sending a message to a designated person. The designated person may be the consumer. The message may be an email, a text message, a voice message, a screen message on a computer screen, or other form of communication. The product recall apparatus 132 may send the message in conjunction with causing the product 120 to provide a notification to the consumer.

In certain embodiments, the consumer can specify a preferred manner in which the product recall apparatus 132 sends the message. The consumer may specify a preference for text messages, emails, or other forms of communication, and provide necessary information to allow the product recall apparatus 132 to communicate with the consumer.

The consumer may also be permitted to specify the sensitivity of the product recall apparatus 132. The consumer may provide the product recall apparatus 132 with a sensitivity indicator for one or more products 120 for which the product recall apparatus 132 has product identification. The sensitivity indicator may be for a particular product 120, or for classes of products 120. The sensitivity indicator may specify one or more conditions that, when met, causes the product recall apparatus 132 to notify the consumer of the recall information for products 120 with a sensitivity indicator associated with them.

For example, a consumer may set a high sensitivity for food products 120. The high sensitivity indicator may cause all product recall information related to food safety to be sent to the consumer regardless of whether the product recall apparatus 132 lists affected food items as in the consumer's possession. A consumer may set a separate sensitivity indicator for major appliances. A particular consumer may specify in this sensitivity indicator that she only wishes to receive product recall information associated with a voluntary recall by a manufacturer, or a mandatory recall ordered by a government agency. Thus, a report on a news website of suspected problems with the consumer's washing machine 120 will not be sent to the consumer unless an actual recall is put in place.

As mentioned above, the product recall apparatus 132 may allow the consumer to set a sensitivity indicator for a given product 120, or for classes of products 120. The product recall apparatus 132 may provide varying granularity of classes. For example, one class may be electronics, and a sub-class of electronics may be appliances. The product recall apparatus 132 may allow the consumer to define her own classes. When the conditions associated with the sensitivity indicator are met, the product recall apparatus 132 may send an appropriate notification.

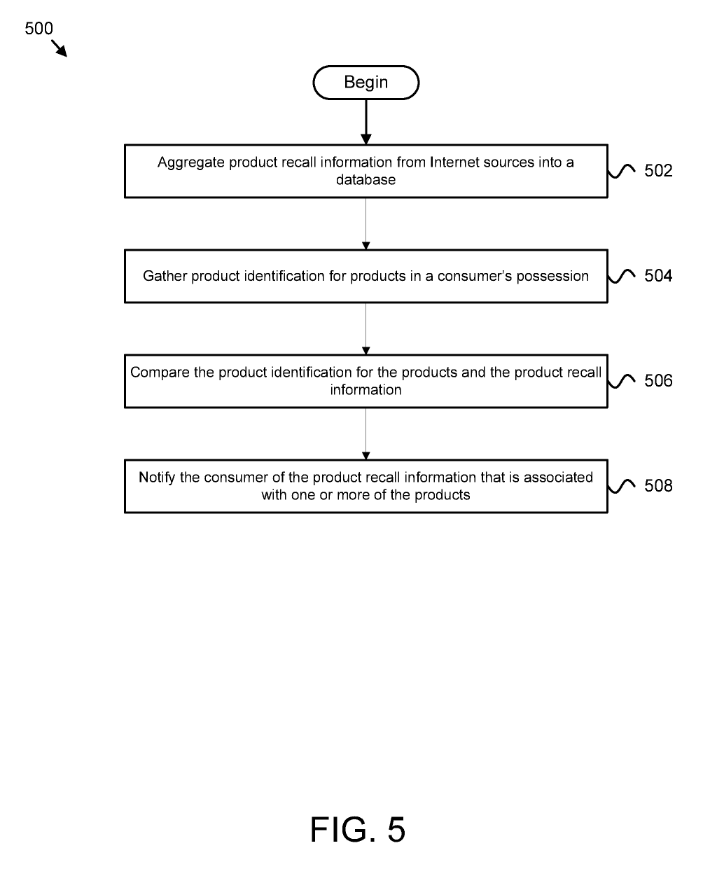

FIG. 5 shows one embodiment of a method 500 for providing relevant safety information to a consumer. The method 500 involves aggregating 502 product recall information from Internet sources into a database. The database may be saved on a server 140, a computing device 130 owned by the consumer, or other approach to saving product recall information in a retrievable format. The method 500 may also involve gathering 504 the product identification for the products 120 that are in the consumer's possession. The method 500 may also include comparing 506 the product identification for the products 120 with the product recall information that has been aggregated into the database, and notifying 508 the consumer of the product recall information that is associated with one or more of the products 120. The notification may be by way of email, text message, a message displayed by the product 120, or other variety of notification.

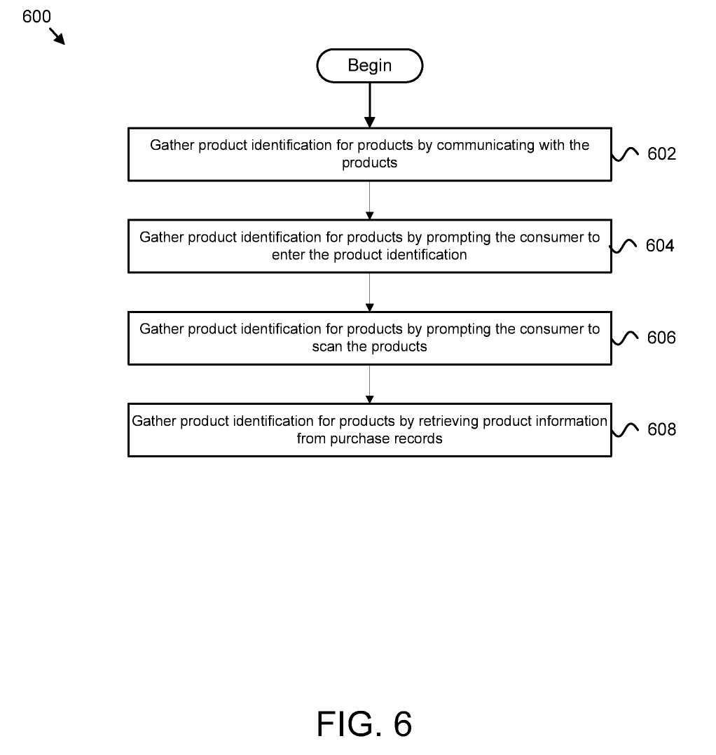

FIG. 6 illustrates one embodiment of a method 600 illustrating an approach to gathering product identification for products in a consumer's possession. In one embodiment, the method 600 involves gathering 602 product identification for the products 120 by communicating with the products 120. As explained above, certain products 120 may have components allowing the products 120 to communicate information directly with the product recall apparatus 132. The product recall apparatus 132 may be configured to gather product identification directly from the products 120 by communicating with the products 120 and requesting product identification.

The method 600 may also involve gathering 604 product identification for products 102 by prompting the consumer to enter the product identification. The consumer may, in response, manually enter the product identification into the product recall apparatus 132. In certain embodiments, the method 600 involves gathering 606 product identification for products by prompting the consumer to scan the products 120. The consumer may scan the products using a cellular phone with an appropriate bar code reader, QR reader, or other technology, or using other appropriate hardware.

The method 600 may further involve gathering 608 product information for products 120 by retrieving product information from purchase records. The product recall apparatus 132 may request purchase records on behalf of the consumer from relevant vendors, financial services providers (such as banks, credit card providers, and others), or other entities that may have product identification for the products 120 generated as part of the purchase. In certain embodiments, the product recall apparatus 132 checks for duplicate entries that may have been generated from various gathering approaches. The product recall apparatus 132 may consolidate duplicate entries for a particular product 120 into a single entry.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product stored on a computer-readable storage medium for providing relevant product safety information, the computer program product comprising instructions for:
aggregating product recall information from a plurality of Internet sources into a database;
gathering product identification for products in a consumer's possession by communicating with the products and storing the product information in a data structure;
comparing the product identification for the products and the product recall information; and
notifying the consumer of the product recall information that is associated with one or more of the products.

2. The computer program product of claim 1, further comprising gathering product information for products in a consumer's possession by one or more of: the consumer entering the product identification; and a user scanning the products.

3. The computer program product of claim 2, further comprising determining a lifetime for one or more of the products.

4. The computer program product of claim 3, further comprising removing the one or more products from the data structure in response to the completion of the lifetime for the one or more products.

5. The computer program product of claim 1, wherein notifying the user of the product recall information further comprises causing the product to provide a notification.

6. The computer program product of claim 1, further comprising receiving a sensitivity indicator for one or more of the products from the consumer, wherein the sensitivity indicator specifies one or more conditions that, when met, cause the computer program product to notify the consumer of the recall information for the one or more products having the sensitivity indicator.

7. The computer program product of claim 1, wherein notifying the user of product recall information further comprises sending a message to a designated person.

8. The computer program product of claim 1, wherein the product identification comprises at least one of a serial number and a date of manufacture.

9. The computer program product of claim 1, wherein gathering the product identification for the products in the consumer's possession by communicating with the products comprises communicating with the products using one of radio frequency identification (RFID), Bluetooth, and Wi-Fi.

10. A system for providing relevant product safety information, the system comprising:
a first computing device comprising a processor and memory, the memory comprising instructions for:
gathering product identification for products in a consumer's possession by communicating with the products and storing the product information in a data structure;
comparing the product identification for the products with product recall information;
notifying the consumer of the product recall information that is associated with one or more of the products; and
a second computing device comprising a processor and memory, the memory comprising instructions for:
aggregating the product recall information from a plurality of Internet sources into a database; and
communicating the product recall information to the first computing device.

11. The system of claim 10, wherein the first computing device is a home computer and the second computing device is a server, and wherein the first computing device and the second computing device are communicatively connected by the Internet.

12. The system of claim 10, wherein the first computing device further comprises instructions for gathering product information for products in the consumer's possession by one or more of: the consumer entering the product identification; and a user scanning the products.

13. The system of claim 10, wherein the products comprise one or more appliances with wireless communications capability.

14. The system of claim 13, wherein notifying the user of the product recall information further comprises causing the one or more appliances to provide a notification.

15. A method for providing relevant product safety information comprising:
aggregating product recall information from a plurality of Internet sources into a database;
gathering product identification for products in a consumer's possession by communicating with the products and storing the product information in a data structure;
comparing the product identification for the products and the product recall information; and
notifying the consumer of the product recall information that is associated with one or more of the products.

16. The method of claim 15, further comprising gathering product information for products in a consumer's possession by one or more of: the consumer entering the product identification; and a user scanning the products.

17. The method of claim 16, further comprising determining a lifetime for one or more of the products.

18. The method of claim 17, further comprising removing the one or more products from the data structure in response to the completion of the lifetime for the one or more products.

19. The method of claim 15, further comprising receiving a sensitivity indicator for one or more of the products from the consumer, wherein the sensitivity indicator specifies one or more conditions that, when met, causes notifying the consumer of the product recall information for the one or more products having the sensitivity indicator.

20. The method of claim 15, wherein gathering the product identification for the products in the consumer's possession by communicating with the products comprises communicating with the products using one of radio frequency identification (RFID), Bluetooth, and Wi-Fi.
